(19) United States
(12) Patent Application Publication
(10) Pub. No.: US 2020/0118418 A1
(43) Pub. Date: Apr. 16, 2020

(54) SOUND MONITORING AND REPORTING SYSTEM

(71) Applicant: Toyota Motor North America, Inc., Plano, TX (US)

(72) Inventor: Dany Benjamin, Rowlett, TX (US)

(21) Appl. No.: 16/158,215

(22) Filed: Oct. 11, 2018

(51) Int. Cl. G08B 25/01; G08G 1/16; B60Q 5/00; G05D 1/00; G10L 15/22

(52) U.S. Cl. CPC G08B 25/016; G08G 1/166; B60Q 5/006; G10L 2015/223; G05D 1/0088; G10L 15/22; G05D 1/0061

(57) ABSTRACT

Methods and systems for detecting and monitoring sounds. The system includes a sound sensor located on a vehicle and configured to detect sound data. The system includes an electronic control unit (ECU) connected to the sound sensor and configured to identify an event based on the detected sound data, determine whether the identified event is associated with an emergency, and determine sound location data based on the detected sound data. The system includes a transceiver of the vehicle configured to communicate an emergency indication, the identified event, and the sound location data. The system includes a remote data server configured to receive the emergency indication, the identified event, and the sound location data, determine an authority or service associated with the identified event, and communicate the identified event and the sound location data to a device associated with the authority or service.

### BACKGROUND

### 1. Field

This specification relates to a system and a method for detecting and monitoring for sounds using a vehicle.

### 2. Description of the Related Art

Conventional vehicles may have cameras located on the exterior of the vehicle. These cameras may be used to provide images to the driver of the environment around the vehicle. These cameras may be particularly useful when parking the vehicle. Other imaging or spatial detection sensors may be used to provide information to the driver about the surroundings of the vehicle. For example, sensors to detect the presence of another vehicle in the driver's blind spot may assist in avoiding collisions between the driver's vehicle and the other vehicle. However, the cameras of conventional vehicles are not used to detect an event for which assistance may be desired, such as an emergency event.

Conventional vehicles may have microphones on the interior of the vehicle, inside of the passenger cabin. These interior microphones may be used to detect voice commands of the driver or to facilitate a telephonic conversation between a passenger and an individual outside of the vehicle. Conventional vehicles do not include microphones for recording sounds outside of the vehicle.

### SUMMARY

What is described is a system for detecting and monitoring sounds. The system includes a sound sensor located on a vehicle and configured to detect sound data. The system includes an electronic control unit (ECU) connected to the sound sensor and configured to identify an event based on the detected sound data, determine whether the identified event is associated with an emergency, and determine sound location data based on the detected sound data. The system also includes a transceiver of the vehicle connected to the ECU and the sound sensor, and configured to communicate an emergency indication, the identified event, and the sound location data. The system includes a remote data server. The remote data server is configured to receive the emergency indication, the identified event, and the sound location data, determine an authority or service associated with the identified event, and communicate the identified event and the sound location data to a device associated with the authority or service.

Also described is a method for detecting and monitoring sounds. The method includes detecting, by a sound sensor of a vehicle, sound data. The method also includes identifying, by an electronic control unit (ECU) of the vehicle, an event based on the detected sound data. The method also includes determining, by the ECU, whether the identified event is associated with an emergency. The method also includes determining, by the ECU, sound location data based on the detected sound data. The method also includes communicating, by a transceiver of the vehicle to a remote data server, an emergency indication, the identified event, and the sound location data. The method also includes determining, by the remote data server, an authority or service associated with the identified event. The method also includes communicating, by the remote data server, the identified event and the sound location data to a device associated with the authority or service.

Also described is a system for detecting and monitoring sounds. The system includes a plurality of vehicles. Each of the plurality of vehicles is configured to detect sound data. Each of the plurality of vehicles is also configured to identify an event based on the detected sound data. Each of the plurality of vehicles is also configured to determine whether the identified event is associated with an emergency. Each of the plurality of vehicles is also configured to determine sound location data based on the detected sound data. The system also includes a remote data server. The remote data server is configured to receive, from each of the plurality of vehicles, respective emergency indications, respective identified events, and respective sound location data. The remote data server is also configured to determine an authority or service associated with the identified events. The remote data server is also configured to communicate the identified events and the sound location data to a device associated with the authority or service.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIG. 1 illustrates a vehicle detecting sound data associated with a sound created by an event, according to various embodiments of the invention.

FIGS. 2A-2D illustrate a process of detecting and reporting an emergency event, according to various embodiments of the invention.

FIG. 3 illustrates the sound monitoring and reporting system, according to various embodiments of the invention.

FIG. 4 illustrates a flow diagram of a process performed by the sound monitoring and reporting system, according to various embodiments of the invention.

### DETAILED DESCRIPTION

Disclosed herein are systems, vehicles, and methods for detecting and monitoring sounds. The systems and methods described herein use sound sensors on the exterior of a vehicle to detect sound data. The sound data is analyzed to identify emergency, unique or unusual events. When an emergency event is identified, occupant(s) of the vehicle may be notified, a nearby authority or service (e.g., a police department or fire department) may be notified, and/or other vehicles or mobile devices in the vicinity of the vehicle may be notified.

By using sound sensors on multiple vehicles, a network of emergency event detection devices may be established. As a result, emergencies may be detected and reported sooner than if an individual reports the emergency using conventional means, such as a smartphone or a telephone. In addition, the computer processing capabilities of a vehicle may considerably outweigh the computer processing capabilities of smartphones, and the wider range of areas covered by vehicles also provides an improvement as compared to emergency sound detection by smartphones. The systems and methods described herein necessarily need computers, as responding to an emergency is a time-sensitive task that requires the use of powerful computing devices configured particularly for the detection and reporting of emergencies.

By implementing the systems and methods described herein, communities may be able to better and more quickly respond to emergencies, as they may be automatically reported to the appropriate authority or service. For example, when a gun is fired, a normal human being may either (a) not recognize that what he/she heard was a gunshot, (b) fail to take action on the hearing of the gunshot, or (c) not be able to provide useful information to the police department other than that they think they heard a gunshot and where they are currently located. Instead, the systems and methods described herein are able to recognize the sound of the gunshot, determine a location of where the gun was fired, and automatically contact the police department to report the detection of an emergency situation and the location of the emergency situation. As illustrated by the example, the systems and methods described herein provide significant improvements to the ways emergencies are currently detected and reported.

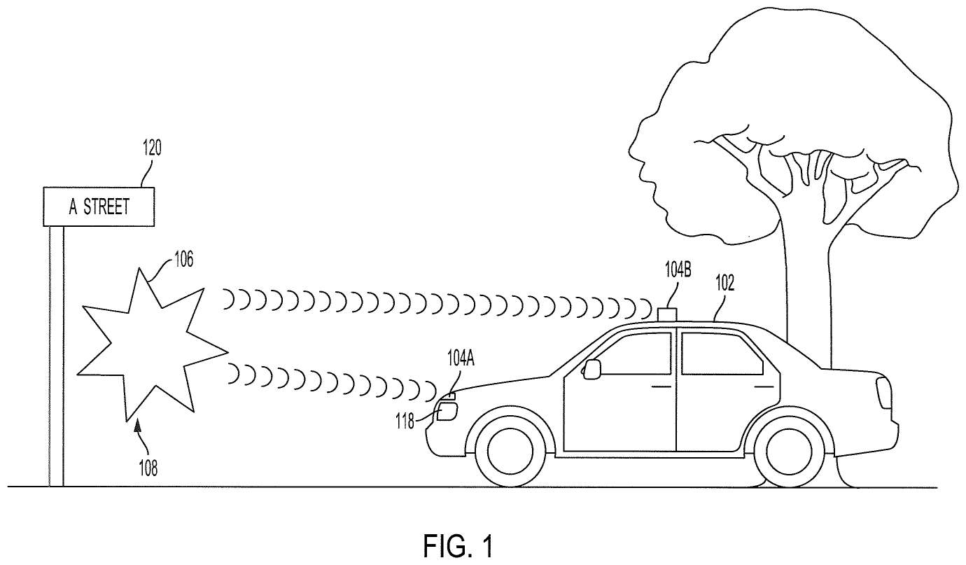

FIG. 1 illustrates a vehicle using the sound monitoring and reporting system. The vehicle 102 includes one or more sound sensors 104 (e.g., front sound sensor 104A and top sound sensor 104B). The sound sensors 104 may be microphones or any other device configured to detect sound data or audio data. The sound sensors 104 may be located in multiple locations on the vehicle 102, such as the front of the vehicle 102, the top of the vehicle 102, or the back of the vehicle 102.

The distance between the sound sensors 104 may be known, and the timing difference in detection of particular sounds by the various sound sensors 104 may be used to determine a distance of the source of the sound from the vehicle 102. For example, a sound 106 may be created. The sound 106 may travel in wave form and be detected first by the front sound sensor 104A and may be detected second by the top sound sensor 104B. The top sound sensor 104B may be elevated and behind the front sound sensor 104A. Based on the timing of the detection of the sound 106 by the front sound sensor 104A and the top sound sensor 104B, a distance to the sound source location 108 of the sound 106 may be determined. The sound sensors 104 may be able to detect the sound 106 up to 1 mile away or greater.

In some embodiments, the vehicle 102 may not be able to determine the sound source location 108, but may be able to determine a general direction and/or distance of the sound source location 108 relative to the location of the vehicle 102. The general direction may be expressed relative to the direction of the vehicle 102 (e.g., to the right of the vehicle), or may be expressed relative to cardinal directions (e.g., northwest of the vehicle). The general direction may be a precise direction (e.g., 45 degrees to the right of the vehicle relative to the front of the vehicle) or a range of angles (e.g., between 5 degrees to the right of the vehicle and 30 degrees to the right of the vehicle, relative to the front of the vehicle). The general distance may be an approximate distance such as about 500 feet from the vehicle 102.

In some embodiments, supplementary data may be used in addition to or in lieu of the sound data to determine the sound source location 108 or the direction of the sound source location 108 relative to the location of the vehicle 102. The vehicle 102 may also include a camera 118 configured to detect image data. The image data may include a location-identifying object, such as a storefront, a landmark, or a street sign 120, for example. The vehicle 102 may also include a GPS unit configured to detect location data associated with the vehicle 102.

The vehicle 102 may be configured to determine an event based on the detected sound data from the sound sensors 104. The vehicle 102 may use training data and machine learning techniques to identify the event. For example, the event may be a vehicle accident based on a crash noise, a sign of distress based on a scream, a shooting based on a gunshot sound, a fire based on a sound of fire burning a building or brush, an explosion, or any other event based on the sound of an individual's spoken words.

As will be described further herein, once the vehicle 102 identifies the event associated with the sound, the vehicle 102 may determine whether the identified event is associated with an emergency. When the vehicle 102 determines that an emergency may be associated with the event, the vehicle 102 may communicate an indication to a third party, such as a police department, a fire department, or a private security department, to report the possible emergency as well as the location of the emergency. The detected sound data and any other supplemental data may also be communicated.

For example, the sound 106 may be a gunshot at the sound source location 108. The vehicle 102 may detect sound data associated with the gunshot using the sound sensors 104. The vehicle 102 may determine that the detected sound data is associated with a gunshot and may also determine that a gunshot sound is associated with an emergency. Accordingly, the vehicle 102 may communicate an indication to the local police department. The proper police department to contact may be determined based on the location of the vehicle 102.

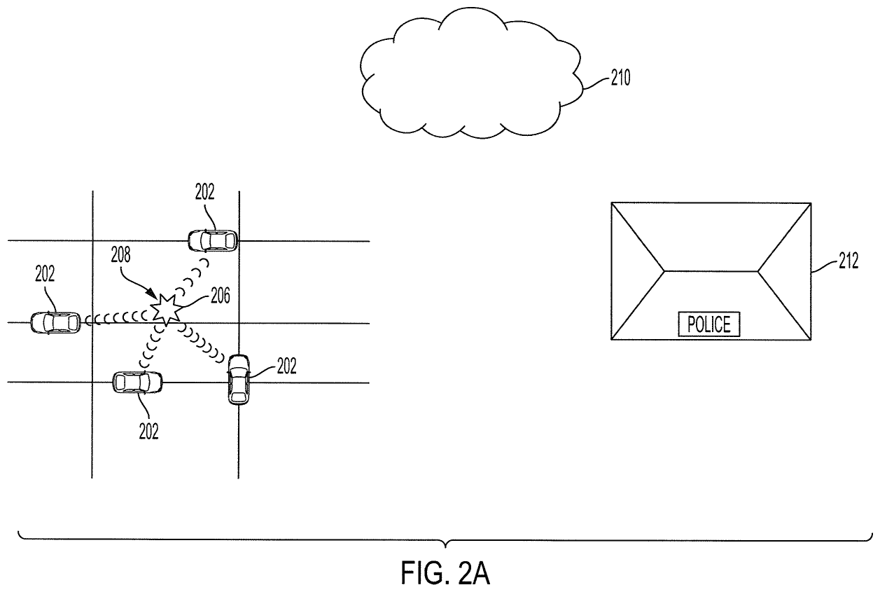

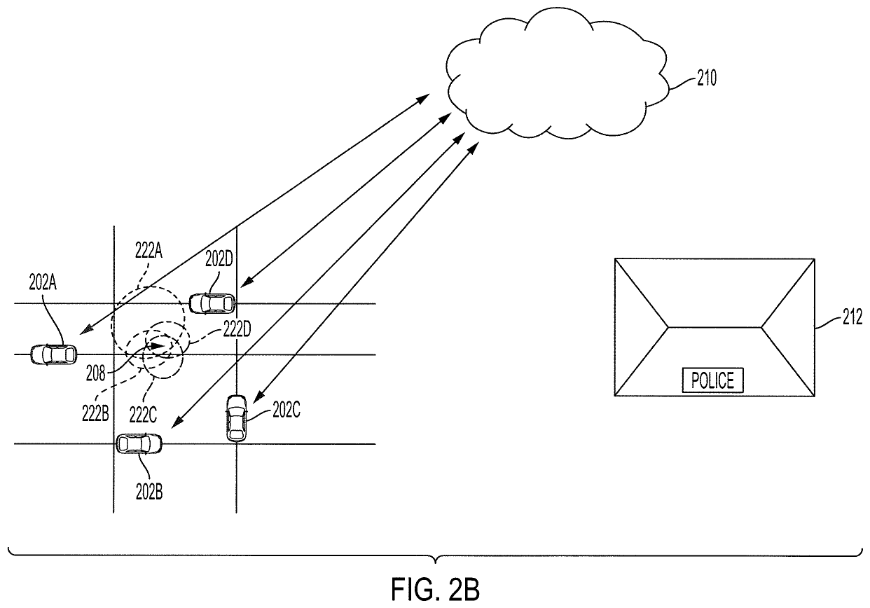

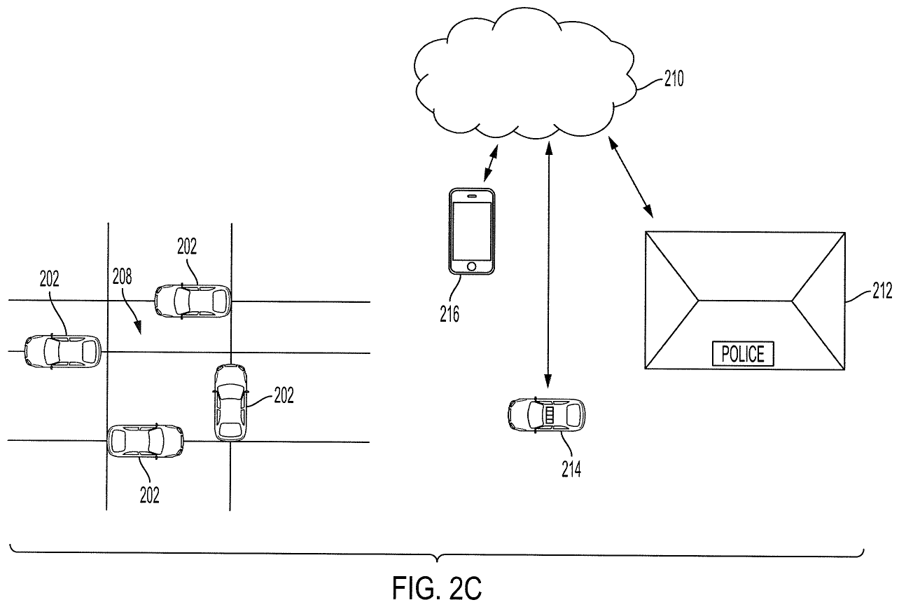

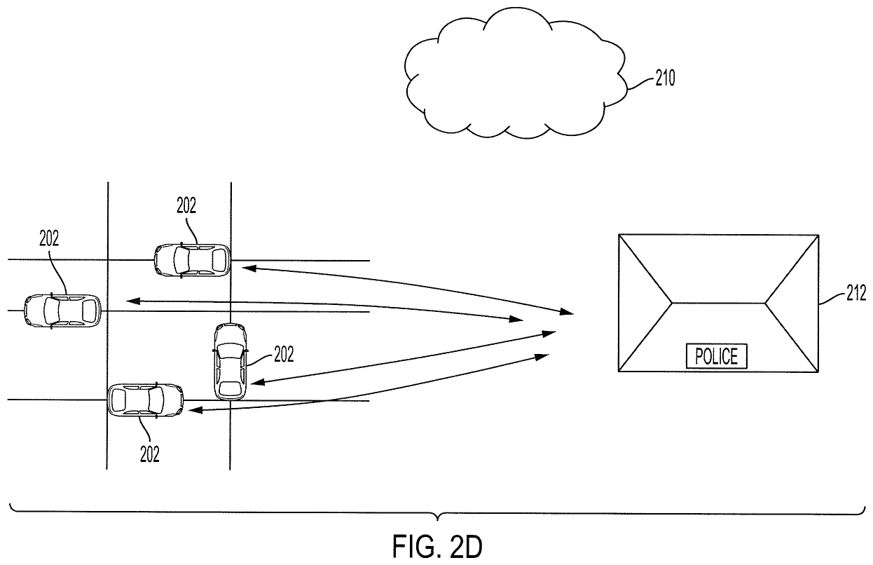

FIGS. 2A-2D illustrate an overhead view of an example process of using the sound monitoring and reporting system with multiple vehicles. The vehicles 202 are similar to the vehicle 102 in FIG. 1. Also illustrated are a remote data server 210 and an authority or service 212, illustrated as a police station.

As shown in FIG. 2A, the vehicles 202 are in proximity of a sound source location 208. At the sound source location 208, a sound 206 is created. The sound 206 is detected by the vehicles 202. Sound sensors (e.g., sound sensors 104) of the vehicles 202 may detect the sound data associated with the sound 206. The vehicles 202 may individually identify an event associated with the sound 206, and whether an emergency is associated with the identified event. The vehicles 202 may also individually determine sound location data based on the detected sound data. The sound location data may include the sound source location 208 or a detected direction of the sound. In some embodiments, supplementary data, such as image data and location data may also be used to determine the sound location data, as described herein. The vehicles 202 may use vehicle location data detected by respective GPS units of the vehicles 202 to determine the sound location data.

As shown in FIG. 2B, the vehicles 202 may communicate with the remote data server 210. The vehicles 202 may communicate to the remote data server 210, an indication that a sound associated with an emergency situation was detected. The vehicles 202 may additionally communicate the determined sound location data. In some embodiments, the detected sound data is also communicated to the remote data server 210 to be passed along to the authority or service 212. In some embodiments, the vehicles 202 perform audio analysis on the detected sound data, and the audio analysis data is also communicated to the remote data server 210. The audio analysis data may include additional information associated with the sound, such as a type of firearm that caused the sound 206, a type of material being burned by the fire causing the sound 206, detected words spoken when the sound 206 is a scream, a shout, or other spoken words, or a type of explosive that caused the sound 206, for example.

In some embodiments, the vehicles 202 may be unable to determine the sound source location 208 within a threshold degree of precision, and may instead individually determine a range 222 associated with the sound source location 208. For example, a first vehicle 202A may determine a first range 222A of the sound source location 208. The second vehicle 202B may determine a second range 222B of the sound source location 208. The third vehicle 202C may determine a third range 222C of the sound source location 208. The fourth vehicle 202D may determine a fourth range 222D of the sound source location 208. The intersection of the ranges 222 may be determined to be the sound source location 208. In some embodiments, the remote data server 210 receives the ranges 222 from the vehicles 202 and the remote data server 210 determines the sound source location 208. In some embodiments, the vehicles 202 are able to communicate with each other, and the ranges 222 are communicated to other vehicles, and one or more of the vehicles 202 are able to determine the sound source location 208 based on the shared ranges 222 from the other vehicles, and the determined sound source location 208 is communicated to the remote data server 210.

In some embodiments, the vehicles 202 may be unable to determine the sound source location 208 within a threshold degree of precision, and may instead use the locations of the vehicles that detected the sound to determine the sound source location 208. For example, a first vehicle 202A may have a first vehicle location, the second vehicle 202B may have a second vehicle location, the third vehicle 202C may have a third vehicle location, and the fourth vehicle 202D may have a fourth vehicle location. Using the vehicle locations as a boundary of the area where the sound source location 208 may be located may be sufficiently accurate for the authority or service 212 to investigate and/or provide aid. In some embodiments, the remote data server 210 receives the respective locations from the vehicles 202 and the remote data server 210 determines the boundary of the area where the sound source location 208 may be located. In some embodiments, the vehicles 202 are able to communicate with each other, and the locations of the respective vehicles are communicated to each other, and one or more of the vehicles 202 are able to determine the boundary of the area where the sound source location 208 may be located based on the shared locations of the other vehicles, and the determined boundary of the area where the sound source location 208 may be located is communicated to the remote data server 210.

As shown in FIG. 2C, once the remote data server 210 has received the indication that a sound associated with an emergency situation was detected and the sound location data, the remote data server 210 communicates a subsequent indication to one or more devices. The remote data server 210 may communicate the indication that a sound associated with an emergency situation was detected and the sound location data to a computing device within the authority or service 212. For example, the authority or service 212 may be a police department, and the police department may dispatch one or more officers to the sound source location 208. The remote data server 210 may determine which authority or service 212 to contact based on the determined emergency associated with the sound. For example, when the determined emergency is a gunshot, the police department may be contacted. In another example, when the determined emergency is a fire, the fire department may be contacted. The vehicles 202 and/or the remote data server 210 may determine the type of emergency and/or the corresponding authority or service to contact.

The remote data server 210 may communicate the indication that a sound associated with an emergency situation was detected and the remote data server 210 may also communicate sound location data to one or more emergency vehicles 214 associated with an authority or service. For example, the emergency vehicle 214 may be one or more police vehicles when the emergency situation is associated with a gunshot. The determination of which emergency vehicle 214 to contact may be based on the location of the emergency vehicle 214. For example, the closest emergency vehicle to the sound source location 208 may be contacted, or all emergency vehicles within a particular radius of the sound source location 208 may be contacted. In some embodiments, the remote data server 210 is aware of the location of one or more emergency vehicles in order to make the determination of which one or more emergency vehicles to contact. The emergency vehicle 214 may automatically provide the driver of the emergency vehicle 214 with turn-by-turn directions to the sound source location 208 in response to receiving the sound location data from the remote data server 210.

The remote data server 210 may communicate the indication that a sound associated with an emergency situation was detected and the remote data server 210 may communicate the sound source location 208 to one or more mobile devices 216. The mobile devices 216 may be associated with the vehicles 202 or may be associated with individuals who work or live within a threshold distance of the sound source location 208. For example, the mobile device of a driver or occupant of the vehicle 202 may be alerted, in order to inform the driver or occupant of the vehicle 202 as to what may have caused the sound, the location of the sound, and that an authority or service has been contacted. In another example, the residents of a neighborhood may opt-in to automated alerts regarding emergency situations within a threshold distance of their residence. The residents may be alerted on their mobile devices with an indication of what may have caused the sound, the location of the sound, and that an authority or service has been contacted.

FIG. 2D illustrates an embodiment where the vehicles 202 directly communicate the indication that a sound associated with an emergency situation was detected and the sound source location 208 to the authority or service 212. The vehicles 202 may determine which authority or service to contact based on the respective locations of the vehicles, and by determining the closest authority or service 212 using map data. In this way, the involvement of the remote data server 210 is obviated, and the authority or service 212 may be notified sooner than if the remote data server 210 were used to facilitate communication with the authority or service 212. In this example, substantially all of the computing is performed by the vehicles 202, resulting in improved computing efficiency compared to a system where substantially all of the computing is performed by the remote data server 210. Even in the processes illustrated in FIGS. 2B and 2C using the remote data server 210, most of the computing is performed by the vehicles, resulting in a system with substantially reduced computing bottlenecks as compared to a system where the remote data server 210 performs substantially all of the computing.

In some embodiments, the remote data server 210 may not communicate the indication that a sound associated with an emergency situation was detected to the authority or service 212, the emergency vehicle 214, or the mobile devices 216 unless a threshold number of vehicles (e.g., at least 3 vehicles) communicate similar identifications of detection of an emergency. In this way, other vehicles may function to corroborate the detection of an emergency event from a single vehicle.

In some situations, the remote data server 210 may receive different identifications of events. For example, the remote data server 210 may receive, from a first vehicle, an identification of an explosion, and the remote data server 210 may receive, from a second vehicle, an identification of a fire. In some embodiments, the remote data server 210 contacts all of the authorities or services associated with all identified events. In the example, the remote data server 210 may contact the police department based on the identification received from the first vehicle, and may also contact the fire department based on the identification received from the second vehicle. In some embodiments, a default authority or service, such as 9-1-1 is contacted when the remote data server 210 receives different identifications of events from the vehicles 202. In some embodiments, the remote data server 210 determines the authority or service to contact based on a number of identifications of events received from the vehicles 202. For example, when the remote data server 210 receives three (3) identifications of a fire and one (1) identification of a shooting, the remote data server 210 may contact the authority or service associated with the fire (e.g., the fire department).

When the vehicles 202 which detected the emergency situation are autonomously driven or semi-autonomously driven, the vehicles 202 may automatically be driven away from the location of the emergency situation. In some embodiments, the autonomous or semi-autonomous vehicles are automatically driven away from the location of the emergency event once the vehicles determine that the detected sound data is associated with an emergency. In some embodiments, the autonomous or semi-autonomous vehicles receive a confirmation from the remote data server 210 that the detected sound data is indeed associated with an emergency, and in response, the autonomous or semi-autonomous vehicles are automatically driven away from the location of the emergency event.

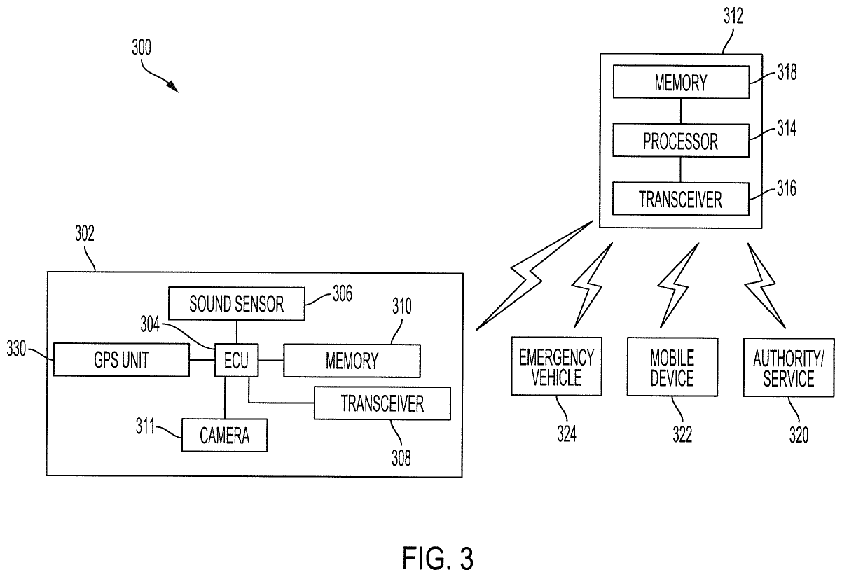

FIG. 3 illustrates a block diagram of the system 300. The system 300 includes a vehicle 302 similar to the vehicle 102 described in FIG. 1 and the vehicles 202 in FIG. 2.

The vehicle 302 may have an automatic or manual transmission. The vehicle 302 is a conveyance capable of transporting a person, an object, or a permanently or temporarily affixed apparatus. The vehicle 302 may be a self-propelled wheeled conveyance, such as a car, a sports utility vehicle, a truck, a bus, a van or other motor or battery driven vehicle. For example, the vehicle 302 may be an electric vehicle, a hybrid vehicle, a plug-in hybrid vehicle, a fuel cell vehicle, or any other type of vehicle that includes a motor/generator. Other examples of vehicles include bicycles, trains, planes, or boats, and any other form of conveyance that is capable of transportation. The vehicle 302 may be a semi-autonomous vehicle or an autonomous vehicle. That is, the vehicle 302 may be self-maneuvering and navigate without human input. An autonomous vehicle may use one or more sensors and/or a navigation unit to drive autonomously.

The vehicle 302 includes an ECU 304 connected to sound sensor 306, a transceiver 308, a memory 310, a camera 311, and a GPS unit 330. The ECU 304 may be one or more ECUs, appropriately programmed, to control one or more operations of the vehicle. The one or more ECUs 304 may be implemented as a single ECU or in multiple ECUs. The ECU 304 may be electrically coupled to some or all of the components of the vehicle. In some embodiments, the ECU 304 is a central ECU configured to control one or more operations of the entire vehicle. In some embodiments, the ECU 304 is multiple ECUs located within the vehicle and each configured to control one or more local operations of the vehicle. In some embodiments, the ECU 304 is one or more computer processors or controllers configured to execute instructions stored in a non-transitory memory 310.

The sound sensor 306 may include one or more sound sensors (e.g., sound sensors 104). As described herein, the sound sensor 306 may be one or more microphones or any other device configured to detect sound data or audio data. The sound sensor 306 may be located in any location on the vehicle 302, such as the front of the vehicle 302, the top of the vehicle 302, and/or the back of the vehicle 302. The sound sensor 306 may be a plurality of directionally oriented sound sensors which are configured to detect sounds within a predetermined range of direction relative to the vehicle. When the directionally oriented sound sensors are used, comparing the intensity of sound detection may result in a determination of the approximate location and direction of the sound source location.

The vehicle 302 may be coupled to a network. The network, such as a local area network (LAN), a wide area network (WAN), a cellular network, a digital short-range communication (DSRC), the Internet, or a combination thereof, connects the vehicle 302 to a remote data server 312.

The transceiver 308 may include a communication port or channel, such as one or more of a Wi-Fi unit, a Bluetooth® unit, a Radio Frequency Identification (RFID) tag or reader, a DSRC unit, or a cellular network unit for accessing a cellular network (such as 3G or 4G). The transceiver 308 may transmit data to and receive data from devices and systems not physically connected to the vehicle. For example, the ECU 304 may communicate with the remote data server 312. Furthermore, the transceiver 308 may access the network, to which the remote data server 312 is also connected.

The GPS unit 330 is connected to the ECU 304 and configured to determine location data. The ECU 304 may use the location data along with map data stored in memory 310 to determine a location of the vehicle. In other embodiments, the GPS unit 330 has access to the map data and may determine the location of the vehicle and provide the location of the vehicle to the ECU 304.

The ECU 304 may use the location data from the GPS unit 330 and a detected direction and distance of the sound to determine the sound location data associated with the sound. The ECU 304 may simply provide the location of the vehicle 302 using the GPS unit 330 to one or more other vehicles 302 and/or the remote data server 312, so that the one or more other vehicles 302 and/or the remote data server 312 may use the location data of the vehicle 302 to determine the sound source location.

The memory 310 is connected to the ECU 304 and may be connected to any other component of the vehicle. The memory 310 is configured to store any data described herein, such as the sound data, image data, map data, the location data, and any data received from the remote data server 312 via the transceiver 308 of the vehicle 302. The memory 310 may store a table indicating whether a particular identified event is an emergency. The memory 310 may also store a plurality of sound profiles used by the ECU 304 to identify an event based on the sound data.

In some embodiments, the ECU 304 periodically deletes stored data from the memory 310 (e.g., stored sound data and image data) after a threshold amount of time has passed, in order to make data storage space available for more recently detected data. For example, after an hour has passed since sound data and/or image data was detected, the ECU 304 may instruct the memory 310 to delete the detected sound data and/or image data.

The sound location data, the indication that a sound associated with an emergency situation was detected, the vehicle location data, the image data, the supplementary data and/or sound data may be communicated from the vehicle 302 to the remote data server 312 via the transceiver 308 of the vehicle 302 and the transceiver 316 of the remote data server 312.

The remote data server 312 includes a processor 314 connected to a transceiver 316 and a memory 318. The processor 314 (and any processors described herein) may be one or more computer processors configured to execute instructions stored on a non-transitory memory. The memory 318 may be a non-transitory memory configured to store data associated with the sound detection and occurrence, such as the sound location data, the indication that a sound associated with an emergency situation was detected, vehicle location data, image data, supplementary data and/or sound data. The memory 318 may store a table of authorities and services corresponding to identified events received from the vehicle. The processor 314 may use the table stored by memory 318 to determine the authority or service corresponding to the identified event received from the vehicle 320. The transceiver 316 may be configured to transmit and receive data, similar to transceiver 308.

The processor 314 of the remote data server 312 may be configured to determine the sound source location when the sound source location is not provided to the remote data server 312 by the vehicle 302. In some embodiments, the vehicle 302 (along with one or more other vehicles similar to vehicle 302) communicates, to the remote data server 312, a range (e.g., range 222) where the sound source location may be. The processor 314 of the remote data server 312 may then determine the sound source location based on the received ranges from the plurality of vehicles. In some embodiments, the vehicle 302 (along with one or more other vehicles similar to vehicle 302) communicates a vehicle location to the remote data server 312. The processor 314 of the remote data server 312 may use the plurality of vehicle locations to determine a boundary of the area where the sound source location may be located.

The remote data server 312 may be communicatively coupled to a computing device of an authority or service 320, a mobile device 322, and/or an emergency vehicle 324. The remote data server 312 may communicate a subsequent indication to one or more devices after the remote data server 312 has received the indication that a sound associated with an emergency from the vehicle 302.

The authority or service 320 may be a service or governmental authority. For example, the authority or service 320 may be a police department, and the police department may dispatch one or more officers to the sound source location after receiving the communication from the remote data server 312. In some embodiments, the memory 318 of the remote data server 312 may store a table of authorities or services to contact for a given situation, and the processor 314 of the remote data server 312 may determine which authority or service 320 to contact based on the situation. For example, when the determined emergency is a gunshot, the police department may be contacted. In another example, when the determined emergency is a fire, the fire department may be contacted. In some embodiments, memory 310 of the vehicle 302 may store a table of authorities or services to contact for a given situation, and the ECU 304 of the vehicle 302 may determine which authority or service 320 to contact based on the situation.

While only one vehicle 302 is shown, any number of vehicles may be used. Likewise, while only one remote data server 312 is shown, any number of remote data servers in communication with each other may be used. Multiple remote data servers may be used to increase the memory capacity of the data being stored across the remote data servers, or to increase the computing efficiency of the remote data servers by distributing the computing load across the multiple remote data servers. Multiple vehicles may be used to increase the robustness of sound source location data, vehicle data, sound data, supplementary data, and vehicle location data considered by the processor 314 of the remote data server 312.

As used herein, a “unit” may refer to hardware components, such as one or more computer processors, controllers, or computing devices configured to execute instructions stored in a non-transitory memory.

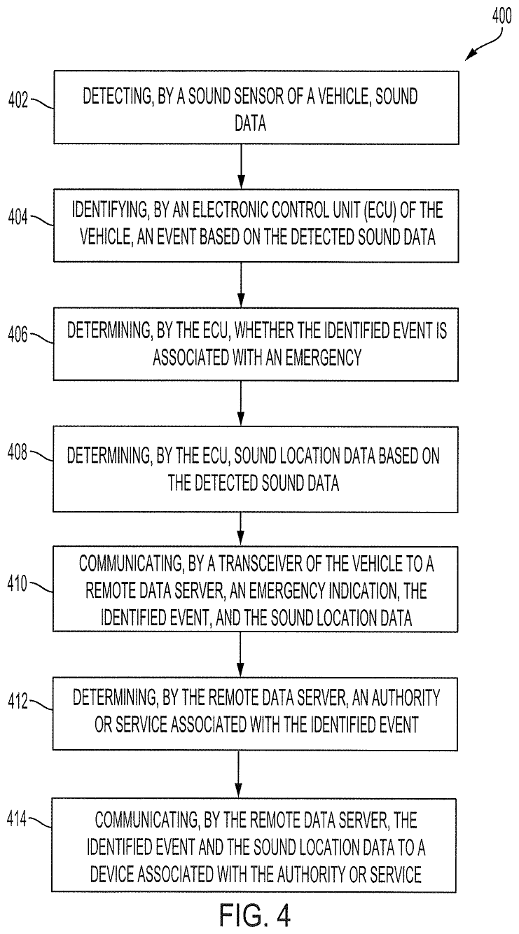

FIG. 4 is a flow diagram of a process 400 for detecting and monitoring sounds. A sound sensor (e.g., sound sensor 306) of a vehicle (e.g., vehicle 302) detects sound data (step 402). The sound sensor may be one or more microphones located on the exterior of the vehicle.

An ECU (e.g., ECU 304) of the vehicle is connected to the sound sensor and the ECU identifies an event based on the detected sound data (step 404). The ECU may compare the detected sound data to a database of known sounds in order to identify the event. In some embodiments, machine learning is used by the ECU in order to identify the event based on the detected sound data.

The ECU determines whether the identified event is associated with an emergency (step 406). In some embodiments, the ECU is connected to a memory (e.g., memory 310) that stores a table of events and whether the event is an emergency.

The ECU determines sound location data based on the detected sound data (step 408). In some embodiments, the sound location data includes an indication of where the detected sound data originated from. In some embodiments, the sound location data includes an approximate range of where the detected sound data originated from. In some embodiments, the sound location data includes a general direction relative to the vehicle where the sound data originated from. The sound location data may be determined by the ECU based on the detection of the sound data from multiple sound sensors of the vehicle. The timing and the distance separating the sound sensors may be used to calculate a distance traveled by the detected sound data.

Once the ECU has determined that the identified event is associated with an emergency, a display screen located inside of the vehicle may display an alert to the driver of the detection of an emergency, and an indication of the location of the emergency. The display screen may be part of an infotainment unit of the vehicle. The display screen may be a display screen of a mobile device that is communicatively coupled to the ECU of the vehicle.

A transceiver (e.g., transceiver 308) of the vehicle communicates the emergency indication, the identified event, and the sound location data to a remote data server (e.g., remote data server 312) (step 410). The remote data server determines an authority or service associated with the identified event (step 412). The remote data server may have a memory (e.g., memory 318) configured to store a table of authorities or services corresponding to particular identified events. The processor of the remote data server may access the memory to determine the authority or service corresponding to the received identified event.

The remote data server communicates the identified event and the sound location data to a device associated with the authority or service (step 414). The device associated with the authority or service may be a computer, a mobile device, or a vehicle of the authority or service.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A system for detecting and monitoring sounds, comprising:
a sound sensor located on a vehicle and configured to detect sound data;
an electronic control unit (ECU) connected to the sound sensor and configured to identify an event based on the detected sound data, determine whether the identified event is associated with an emergency, and determine sound location data based on the detected sound data;
a transceiver of the vehicle connected to the ECU and the sound sensor, and configured to communicate an emergency indication, the identified event, and the sound location data; and
a remote data server configured to:
receive the emergency indication, the identified event, and the sound location data,
determine an authority or service associated with the identified event, and
communicate the identified event and the sound location data to a device associated with the authority or service.

2. The system of claim 1, wherein the sound location data includes at least one of a sound source location, a range where the sound source location is located, or a direction relative to the vehicle of the sound source location.

3. The system of claim 1, wherein the sound sensor is a plurality of microphones separated by known distances, and wherein the ECU is further configured to determine the sound location data based on the sound data from the plurality of microphones and a timing of detection of the sound data by the plurality of microphones.

4. The system of claim 1, further comprising a GPS unit of the vehicle configured to detect vehicle location data,
wherein the sound location data includes the vehicle location data, and
wherein the remote data server is further configured to:
receive a plurality of sound location data from a plurality of vehicles,
determine a boundary where a sound source location is located based on the vehicle location data of the plurality of vehicles, and
communicate the boundary to the device associated with the authority or service.

5. The system of claim 1, wherein the transceiver of the vehicle is further configured to receive sound location data from one or more other vehicles, and
wherein the ECU is further configured to determine a sound source location based on the detected sound data and the received sound location data from the one or more other vehicles.

6. The system of claim 1, further comprising a memory connected to the ECU and configured to store the detected sound data, and
wherein the ECU is further configured to periodically delete the detected sound data after a threshold amount of time has passed.

7. The system of claim 1, wherein the vehicle is an autonomously driven or semi-autonomously driven vehicle, and
wherein the ECU is further configured to automatically drive the vehicle in a direction away from the identified event.

8. A system for detecting and monitoring sounds, comprising:
a plurality of vehicles each configured to:
detect sound data,
identify an event based on the detected sound data,
determine whether the identified event is associated with an emergency, and
determine sound location data based on the detected sound data;
a remote data server configured to:
receive, from each of the plurality of vehicles, respective emergency indications, respective identified events, and respective sound location data,
determine an authority or service associated with the identified events, and
communicate the identified events and the sound location data to a device associated with the authority or service.

9. The system of claim 8, wherein the sound location data includes at least one of a sound source location, a range where the sound source location is located, or a direction relative to the vehicle of the sound source location.

10. The system of claim 8, wherein each vehicle includes a plurality of microphones separated by known distances, and wherein the vehicle is further configured to determine the sound location data based on the sound data from the plurality of microphones and a timing of detection of the sound data by the plurality of microphones.

11. The system of claim 8, wherein the remote data server is further configured to:
determine a sound source location based on the respective sound location data received from the plurality of vehicles, and
communicate, to one or more devices located within a threshold distance of the sound location, the identified event.

12. The system of claim 8, wherein each vehicle includes a GPS unit configured to detect vehicle location data,
wherein the sound location data includes the vehicle location data, and
wherein the remote data server is further configured to:
receive a plurality of sound location data from a plurality of vehicles,
determine a boundary where a sound source location is located based on the vehicle location data of the plurality of vehicles, and
communicate the boundary to the device associated with the authority or service.

13. The system of claim 8, wherein each vehicle of the plurality of vehicles is configured to:
receive sound location data from one or more other vehicles from the plurality of vehicles, and
determine a sound source location based on the determined sound location data and the received sound location data from the one or more other vehicles.

14. A method for detecting and monitoring sounds, the method comprising:
detecting, by a sound sensor of a vehicle, sound data;
identifying, by an electronic control unit (ECU) of the vehicle, an event based on the detected sound data;
determining, by the ECU, whether the identified event is associated with an emergency;
determining, by the ECU, sound location data based on the detected sound data;
communicating, by a transceiver of the vehicle to a remote data server, an emergency indication, the identified event, and the sound location data;
determining, by the remote data server, an authority or service associated with the identified event; and
communicating, by the remote data server, the identified event and the sound location data to a device associated with the authority or service.

15. The method of claim 14, wherein the sound location data includes at least one of a sound source location, a range where the sound source location is located, or a direction relative to the vehicle of the sound source location.

16. The method of claim 14, wherein the ECU determines the sound location data based on the sound data from a plurality of microphones located on the vehicle, and a timing of detection of the sound data by the plurality of microphones.

17. The method of claim 14, further comprising automatically driving, by the ECU, the vehicle in a direction away from the identified event.

18. The method of claim 14, further comprising detecting, by a GPS unit of the vehicle, vehicle location data, the sound location data including the vehicle location data;
receiving, by the remote data server, a plurality of sound location data from a plurality of vehicles;
determining, by the remote data server, a boundary where a sound source location is located based on the vehicle location data of the plurality of vehicles; and
communicating, by the remote data server to the device associated with the authority or service, the boundary.

19. The method of claim 14, further comprising receiving, by the transceiver, sound location data from one or more other vehicles; and
determining, by the ECU, a sound source location based on the detected sound data and the received sound location data from the one or more other vehicles.

20. The method of claim 14, further comprising storing, by a memory connected to the ECU, the detected sound data; and
periodically deleting, by the ECU, the detected sound data after a threshold amount of time has passed.
